(19) United States
(12) Patent Application Publication
(10) Pub. No.: US 2011/0012513 A1
(43) Pub. Date: Jan. 20, 2011

(54) Device for Centerpoint Wavelength Adjustment of Emitted Optical Radiation

(75) Inventor: Sükrü YILMAZ, Berlin (DE)

Correspondence Address: COHEN, PONTANI, LIEBERMAN & PAVANE LLP, 551 FIFTH AVENUE, SUITE 1210, NEW YORK, NY, 10176, US

(73) Assignee: Schmidt + Haensch GmbH & Co., Berlin (DE)

(21) Appl. No.: 12/837,954

(22) Filed: Jul. 16, 2010

(30) Foreign Application Priority Data
Jul. 16, 2009 (DE) 10 2009 033 979.5

(51) Int. Cl. H01J 7/24

(52) U.S. Cl. 315/117

(57) ABSTRACT

Device for centerpoint wavelength adjustment of emitted radiation of an LED unit having at least one interference filter arranged downstream in the optical axis of the LED unit. The LED unit and the interference filter are connected to at least one temperature regulating unit, and the temperature regulating unit is connected to at least one temperature acquisition unit. The temperature acquisition unit acquires the temperature of the LED unit as well as a temperature of the interference filter.

### BACKGROUND OF THE INVENTION

1. Field of the Invention

The present invention is directed to a device for centerpoint wavelength adjustment of emitted radiation of an LED unit having at least one interference filter arranged downstream in an optical axis of the LED unit.

2. Description of the Related Art

Because of the long lifetime and inexpensive fabrication of semiconductors, it is common to use light emitting diodes (LEDs) as a radiation source in precision measuring equipment, e.g., polarimeters, spectrometers, or refractometers.

However, the centerpoint wavelength of the emitted LED radiation must be adjusted very precisely because the physical measuring effects being used are generally heavily dependent upon wavelength.

For example, in a normal solution such as sucrose solution, the wavelength dependency of the measuring effect in a polarimetric measurement is about 0.4% per nanometer. However, the exemplary spread, type-dependent range of the centerpoint wavelength of the emitted radiation dictated by the LED depends very heavily on ambient temperature, on the LED unit, and a temperature of the LED Unit.

The temperature of the LED unit depends at least in part on the electric current, ambient temperature, and on the site where the LED unit is used. Displacements of up to several nanometers can occur as a result of these temperature-influencing variables.

Due to the temperature-influencing variables, a precise measurement by polarimetry is impossible without taking further steps. Lowering or raising the temperature of an LED unit always leads to a displacement of the centerpoint wavelength and, accordingly, to longer or shorter wavelengths of the emitted optical radiation. A device with a temperature-controlled laser diode is known from U.S. Pat. No. 4,701,607 A. U.S. Pat. No. 5,680,410 A discloses a device with an integrated temperature regulating unit. A spectroscope system with a temperature-controlled laser is known from GB 2 292 479 A. Further, EP 0 516 398 A2 discloses a method and a device for controlling the light spectrum of a light emitting diode.

To minimize displacement of the centerpoint wavelength in the measurement beam the prior art describes optical interference filters arranged behind the radiation source. When the emitted radiation spectrum of the radiation source is very broad with respect to the pass band of the optical filter, the centerpoint wavelength is essentially defined by the filter. However, when the pass band of the filter and the spectral width of the emitted radiation are on the same order of magnitude, the filter characteristic multiplied by the radiation spectrum gives a resultant measurement beam.

In both cases, however, the centerpoint wavelength is not stable over the long term because the interference filter is subject to natural aging processes and the pass band changes over time. This change in transmission must be routinely compensated by laboriously changing the position of the filter by tilting the filter in the light beam. The interference filters are also subject to the influences of temperature. The transmission wavelength of the light source being used is dependent upon temperature. Its length increases when temperature rises and correspondingly decreases when temperature decreases.

When the radiation spectrum of the light source and the pass band of the optical filter are on approximately the same order of magnitude, apart from the gradual change in filter characteristics, there may also be a short-term shifting of the centerpoint wavelength of the resulting measurement beam when there is a change in the temperature of the LED unit. It is precisely in this case that a time-consuming readjustment of the optical filter that is performed by changing its position, which cannot succeed in compensating.

### SUMMARY OF THE INVENTION

An object of the present invention to provide a device for the exact and controlled centerpoint wavelength adjustment of the emitted optical radiation of a light emitting diode.

The device according to one embodiment of the invention comprises an LED unit with at least one interference filter arranged downstream in the optical axis of the LED unit. The LED unit and the interference filter are connected to at least one temperature regulating unit. The temperature regulating unit is in turn connected to at least one temperature acquisition unit which acquires the temperature of the LED unit as well as the temperature of the interference filter.

Accordingly, an exact and controlled centerpoint wavelength adjustment of the emitted optical radiation of a light emitting diode can be performed particularly rapidly. Therefore, a mechanical readjustment of the interference filter can be dispensed with.

In a preferred embodiment of the invention, the interference filter is constructed to be rotatable horizontal to and perpendicular to the emitted radiation in the installed position relative to the LED unit. In this way, an exact centerpoint wavelength for a desired operating temperature can be preadjusted.

In a preferred embodiment of the invention, the temperature acquisition unit and the temperature regulating unit are operatively connected to a control unit that adjusts the temperature regulating unit to a determined setpoint or reference value depending on the current or actual values determined by the temperature acquisition unit. Accordingly, as a result of the very short transmission path, a fast temperature acquisition, evaluation, and adjustment can be ensured with the smallest possible losses. To this end, all of the necessary components can be arranged on a base plate.

In another preferred embodiment of the invention, the temperature regulating unit is a Peltier element. Some advantages of a Peltier element are its small size and an absence of any moving parts, which ensures a very compact construction of the device. Further, both cooling and heating can be carried out with the Peltier element by reversing the direction of current.

According to one embodiment of the invention, the LED unit and the temperature acquisition unit are formed in one piece. This provides a particularly compact component, which also allows it to be installed in compact portable devices.

In another advantageous embodiment of the device according to the invention, the LED unit and the interference filter are arranged in close spatial proximity to the temperature acquisition unit and the temperature regulating unit on a common base plate. This ensures a short thermal transmission path. In this respect, it is also conceivable for the Peltier element itself to function as a base plate.

In one embodiment of the invention, a heat sink is associated with the Peltier element. Excess heat can be given off directly to the heat sink. An immediate adjustment to a determined temperature setpoint can be substantially facilitated in this way.

To ensure a standardization of the rated resistance and change in resistance as well as easy exchangeability of the temperature sensor without the need for a subsequent recalibration of the measuring chain, the temperature acquisition unit in one embodiment of the invention is a PT thermistor, a PTC thermistor, an NTC thermistor, or a semiconductor temperature sensor.

According to a preferred embodiment of the invention, the temperature regulating unit is connected to the base plate by a thermally conductive layer. In this way, a thermodynamic transition to the temperature acquisition unit of the LED unit and interference filter which is as loss-free as possible can be ensured.

In one embodiment of the invention, the temperature regulating unit is unidirectional. In this way, a complicated controlling of the temperature regulating unit can be dispensed with.

In one embodiment of the invention, the temperature regulating unit is a heating foil with resistive heating.

In a preferred embodiment of the invention, the temperature regulating unit is a bidirectional temperature control element with associated thermally conductive layer and heat sink. This ensures a short response time to the reference temperature and actual temperature. An increase in temperature and a decrease in temperature can be immediately adjusted in this way.

In one preferred embodiment of the invention, a two position or step controller, a PID controller, or a P controller is associated with the control unit. The PID controller in particular is the most adaptable because it has no steady state error in the reference variable/disturbance variable step and can compensate two delays (T1 elements) in the control path and therefore simplify the control path.

One object of the invention is to provide a method for centerpoint wavelength adjustment of emitted optical radiation for an advantageous device of the kind mentioned above which compensates for the aging-induced optical characteristics of an interference filter arranged downstream.

The method according to the invention for centerpoint wavelength adjustment of emitted radiation of an LED unit in combination with an interference filter comprises connecting the LED unit and the interference filter to a temperature regulating unit and simultaneously acquiring the temperatures of the LED unit and the interference filter by a temperature acquisition unit associated with them, wherein a control unit controls the temperature regulating unit depending on the temperatures of the LED unit and interference filter determined by the temperature acquisition unit and dynamically adjusts an increased temperature or a decreased temperature of the LED unit and interference filter depending on an actual value in relation to the predetermined reference value.

In one embodiment, the temperature of the LED unit and interference filter is adjusted by the temperature regulating unit and monitored by the control unit and adjusted to a determined value and adjusts the centerpoint wavelength value of the emitted radiation of the LED unit depending on the desired centerpoint wavelength by rotating the interference filter in the installed position around the horizontal perpendicular to the emitted radiation of the interference filter.

A method is provided by which a fast and reliable adjustment of the centerpoint wavelength of the emitted radiation of a light emitting diode can be ensured over a long period of time. The aging-dependent centerpoint wavelength shifts in the emitted radiation of the light emitting diode can be compensated in this way.

The invention described above is used in a polarimeter.

The invention described above is used in a refractometer.

The invention described above is used in a spectrometer.

It is to be understood that the features mentioned above and described in the following can be used not only in the indicated combinations or embodiments, but also in other combinations with features of other embodiments or by themselves without departing from the framework of the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully in the following with reference to the accompanying drawing. The drawing shows:

FIG. 1 is a schematic side view of the device according to the invention.

### DETAILED DESCRIPTION OF THE PRESENTLY PREFERRED EMBODIMENTS

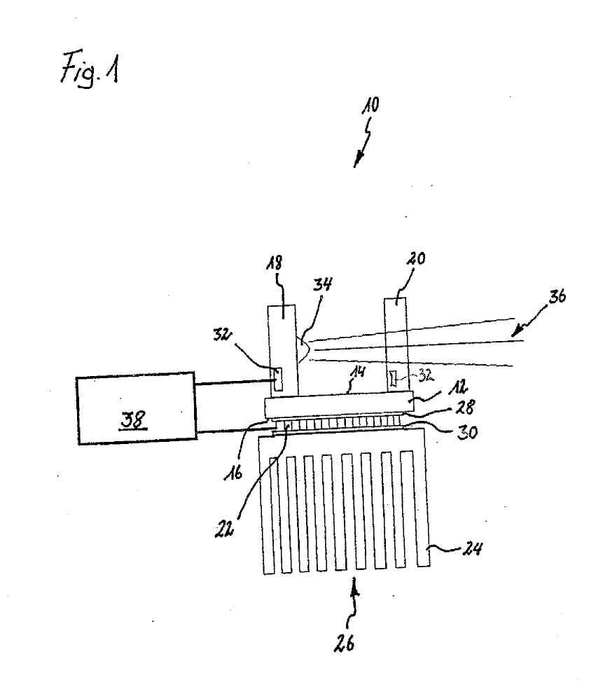

As is shown in FIG. 1, the device 10 comprises a base plate 12 having a top side 14 and a bottom side 16. An LED unit 18, for example, an LED chip, is arranged on the top side 14 of the base plate 12. An interference filter 20 is arranged in a beam path of the LED unit 18, also on the top side 14 of the base plate 12.

The bottom side 16 of the base plate 12 is operatively connected to a temperature regulating unit 22. The temperature regulating unit 22 is in turn connected to a heat sink 24. In this embodiment, the heat sink 24 has a plurality of cooling ribs 26. In addition, a fan unit can be associated with the heat sink 24 so that heat can be dissipated more efficiently.

The temperature regulating unit 22 is preferably constructed in a flat manner and, in this embodiment, is a Peltier element. A thermally conductive layer 28 and a thermally conductive layer 30 are associated with the temperature regulating unit 22 and have approximately the same dimensions as the temperature regulating unit 22. The thermally conductive layers 28 and 30 are constructed in such a way that they form a thermodynamically advantageous transition between the bottom side 16 of the base plate 12 and the cooling means 26.

A temperature acquisition unit 32 is associated with the LED unit 18. In this embodiment, the temperature acquisition unit 32 and LED unit 18 are formed in one piece. The LED unit 18 has a light emitting diode 34. The optical radiation 36 emitted by the light emitting diode 34 is radiated in direction of the interference filter.

The temperature acquisition unit 32 and the temperature regulating unit 22 are connected to one another by a control unit 38. The control unit 38 controls the temperature regulating unit 22 based at least in part on a predetermined reference value and the actual current value acquired by the temperature acquisition unit 32. The temperature regulating unit 22 has substantially the same dimensions as the base plate 12 and controls the temperature of the LED unit 18 and of the interference filter 20 to the same extent.

The functioning of the device and method is described below.

According to one embodiment of the invention, the temperature in the LED unit 18 and interference filter 20 is measured directly by one or more temperature acquisition units 32. The LED unit 18 is connected to a temperature regulating unit 22. The output from the temperature acquisition unit 32 serves as an input to a control unit 38. The output of the control unit 38 is connected to the temperature regulating unit 22. The temperature of the LED unit 18 and interference filter 20 is raised or lowered by the temperature specified by the control unit 38 and generated by the temperature regulating unit 22 so that the centerpoint wavelength of the emitted radiation 36 is displaced to longer or shorter wavelengths and can accordingly be substantially exactly adjusted.

When an optical filter unit, in this case, an interference filter 20, is positioned in front (downstream) of the radiation source, in this case, a light emitting diode 34, an age-related change in the interference filter 20 can be readjusted simply by changing the temperature of the LED unit 18 by the control unit 38 without changing the position of LED unit 18 or interface filter 20 in a time-consuming manner. If the centerpoint wavelength of the emitted radiation 36 should have a determined value, the emitted radiation 36 is acquired by a suitable method, for example, spectrometry, and adjusted to the desired value by the control unit 38. Alternatively, the method can also be a component of a device, for example, a polarimeter or a refractometer, which indirectly determines the value of the centerpoint wavelength of the emitted radiation 36 together with a quartz standard.

Depending on the desired and existing centerpoint wavelength, the value of the centerpoint wavelength of the emitted radiation 36 of the light emitting diode 34 can be preadjusted by tilting the interference filter 20. Any change in wavelength occurring thereafter during the lifetime of the measuring device can be determined, for example, by monitoring measurements using a calibrated quartz plate. The reference value can now be adjusted again by the change in temperature by the control unit 38.

If the centerpoint wavelength of the emitted radiation 36 have a determined value, the output variable of the control unit 38 is adjusted until the emitted radiation 36 has the desired centerpoint wavelength.

The output variable supplied by the temperature acquisition unit 32 is directly applied to the input of a control unit 38 (configured as one of a two position or step controller, a PID controller, a P controller, or the like.). The output of the control unit 38 then adjusts the temperature regulating unit 22 to the specified temperature and accordingly adjusts the centerpoint wavelength.

It should be noted that it is also possible to provide the LED 34 and the interference filter 20 with their own respective temperature regulating unit and temperature acquisition element. However, this is more time-consuming and complex with respect to construction and handling and is therefore comparatively expensive.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A device for centerpoint wavelength adjustment of emitted radiation comprising:
an LED unit;
at least one interference filter arranged downstream in an optical axis of the LED unit;
at least one temperature regulating unit connected to the LED unit and the interference filter and configured to adjust a temperature of the LED unit and the interference filter; and
at least one temperature acquisition unit coupled to the temperature regulating unit,
wherein the temperature acquisition unit acquires a temperature of the LED unit and the temperature of the interference filter.

2. The device according to claim 1, wherein the interference filter is configured to be rotatable horizontally and perpendicularly with respect to the emitted radiation in the installed position relative to the LED unit.

3. The device according to claim 1, further comprising a control unit operatively connected to the temperature acquisition unit and the temperature regulating unit and configured to adjust the temperature regulating unit to a determined reference value based at least in part on actual values determined by the temperature acquisition unit.

4. The device according to claim 1, wherein the temperature regulating unit is a Peltier element.

5. The device according to claim 1, wherein the LED unit and the temperature acquisition unit are formed in one piece.

6. The device according to claim 1, further comprising a common base plate, wherein the LED unit and the interference filter are arranged in close spatial proximity to the temperature acquisition unit and the temperature regulating unit on the common base plate.

7. The device according to claim 4, further comprising a heat sink coupled to the Peltier element.

8. The device according to claim 1, wherein the temperature acquisition unit is one of a PT thermistor, a PTC thermistor, an NTC thermistor, and a semiconductor temperature sensor.

9. The device according to claim 6, wherein the temperature regulating unit is connected to the base plate by a thermally conductive layer.

10. The device according to claim 1, wherein the temperature regulating unit is unidirectional.

11. The device according to claim 1, wherein the temperature regulating unit is a heating foil with resistive heating.

12. The device according to claim 1, wherein the temperature regulating unit is a bidirectional temperature control element coupled by a thermally conductive layer to a heat sink.

13. The device according to claim 3, wherein the control unit comprises at least one of a two-position controller, a PID controller, and a P controller.

14. A method for centerpoint wavelength adjustment of emitted radiation from an LED unit in combination with an interference filter, wherein the LED unit and the interference filter are connected to at least one temperature regulating unit, the method comprising:
acquiring a temperature of the LED unit and a temperature of the interference filter simultaneously;
determining respective temperatures of the LED unit and the interference filter;
controlling the temperature regulating unit based at least in part on the determined respective temperatures of the LED unit and the interference filter; and
dynamically performing a temperature increase or a temperature decrease of the LED unit and interference filter based at least in part on an actual temperature value in relation to a predetermined reference value.

15. The method according to claim 14, further comprising:
monitoring the temperature of the LED unit and interference filter;
adjusting the temperature of the LED unit and interference filter to a determined value; and
adjusting a centerpoint wavelength value of emitted radiation of the LED unit based at least in part on a desired centerpoint wavelength by rotating the interference filter in an installed position around a horizontal axis that is perpendicular to the emitted radiation.

16. The device according to claim 1, wherein the device is integrated into at least one of a polarimeter, a refractometer, and aspectrometer.

17. A device for centerpoint wavelength adjustment of emitted radiation, comprising:
a baseplate having a first side and a second side opposite the first side;
an LED unit mounted on the first side of the baseplate having at least one LED that emits radiation;
an interference filter mounted on the first side of the baseplate arranged to receive the emitted radiation of the LED;
at least one temperature acquisition unit coupled to the LED unit configured to acquire a temperature of the LED unit;
a temperature regulating device coupled to the second side of the baseplate; and
a heatsink coupled to the temperature regulating device opposite the baseplate,
wherein variations in temperature vary the centerpoint wavelength of the emitted radiation.

18. The device for centerpoint wavelength adjustment of emitted radiation according to claim 17, further comprising:
a control unit coupled to the at least one temperature acquisition unit and the temperature regulating device,
the control unit configured to control the temperature regulating device based at least in part on at least one of:
a predetermined LED unit temperature value and
a temperature acquired by the at least one temperature acquisition unit.

19. The device for centerpoint wavelength adjustment of emitted radiation according to claim 18, wherein the temperature regulating device is a Peltier element

20. The device according to claim 19, wherein the interference filter, in an installed position, is rotateable around a horizontal axis that is perpendicular to the emitted radiation.
